(19) United States
(12) Patent Application Publication
(10) Pub. No.: US 2004/0050769 A1
(43) Pub. Date: Mar. 18, 2004

(54) Liquid mixture separators

(76) Inventor: Henry P. Sheng, Claremont, CA (US)

Correspondence Address: Boniard I. Brown, 1500 West Covina Parkway, #113, West Covina, CA, 91790-2793, US

(21) Appl. No.: 10/245,052

(22) Filed: Sep. 16, 2002

(51) Int. Cl. B01D 17/022

(52) U.S. Cl. 210/287; 210/DIG. 5

(57) ABSTRACT

A liquid mixture separator utilizes particles which attracts one liquid of a mixture and does not attract a second liquid of the mixture. The mixture is introduced into a separator wherein a first liquid is attracted to the particles and the second liquid of the mixture is not attracted. The separated first liquid is passed outwardly via a filter which retains the particles, and the separated second liquid is drained from the separator.

### BACKGROUND AND SUMMARY OF THE INVENTION

The present invention relates to separators for the continuous separation of liquid mixtures.

The invention utilizes differential surface wettability characteristics of solid material particles with respect to two liquids of a liquid mixture. Known technology is utilized relative to fluidization of particles in the separation of liquids of the liquid mixture, which may contain some non-permanent emulsion. Fluidization of particles enables the provision of a dynamic filter device which may operate continuously.

The invention has particular application for the separation of oil-water mixtures, and is applicable to separation of other liquid mixtures.

Certain materials, generally plastics, are oleophilic so that they repel water and have affinity for oil. These include the polyethylenes, polypropylenes, polyamides and polyurethanes. An oil-water separator is known in the art as a coalescer.

Large settling tanks have long been utilized for separation of liquid mixtures, and are often of great size, and require substantial maintenance and operational control.

As known in the art, the wettability of a material by a particular liquid is defined by the contact angle between a drop of the liquid and a plane surface of the particular material on which the drop of the liquid is resting. Respective liquids exhibit varying degrees of wettability with respect to particular materials. Contact angles between the liquid and the material are possible between 0° and 180°. A contact angle of less than 90° is considered to wet the material, and a contact angle of greater than 90° is said not to wet the material. The relevant technology is outlined in U.S. Pat. No. 3,471,018 at column 4, and is discussed in a reference work on surface chemistry, “The Chemistry and Physics of Interfaces”, published by American Chemical Society, Washington, D.C., 1965.

The present invention provides a liquid mixture separator for separating first and second liquids, which comprises a first chamber to contain a liquid mixture, and a second chamber in communication with the first chamber and communicating therewith via a screen wall. A substantial plurality of particles is disposed in the first chamber in contact with the liquid mixture, the particles comprising material which attracts the first liquid and does not attract the second liquid so that the first liquid congregates on the particles. Separated second liquid passes from the first chamber via the screen wall. Outlet means are provided, and comprise separate outlet means for the separated first liquid and the second liquid.

The particles are typically formed of one of polystyrene, polyethylene, polypropylene, or polyamide. The particles are formed of material having appropriate wettability angles.

### BRIEF DESCRIPTION OF THE DRAWING

FIG. 1 is a sectional view of a liquid mixture separator according to the present invention.

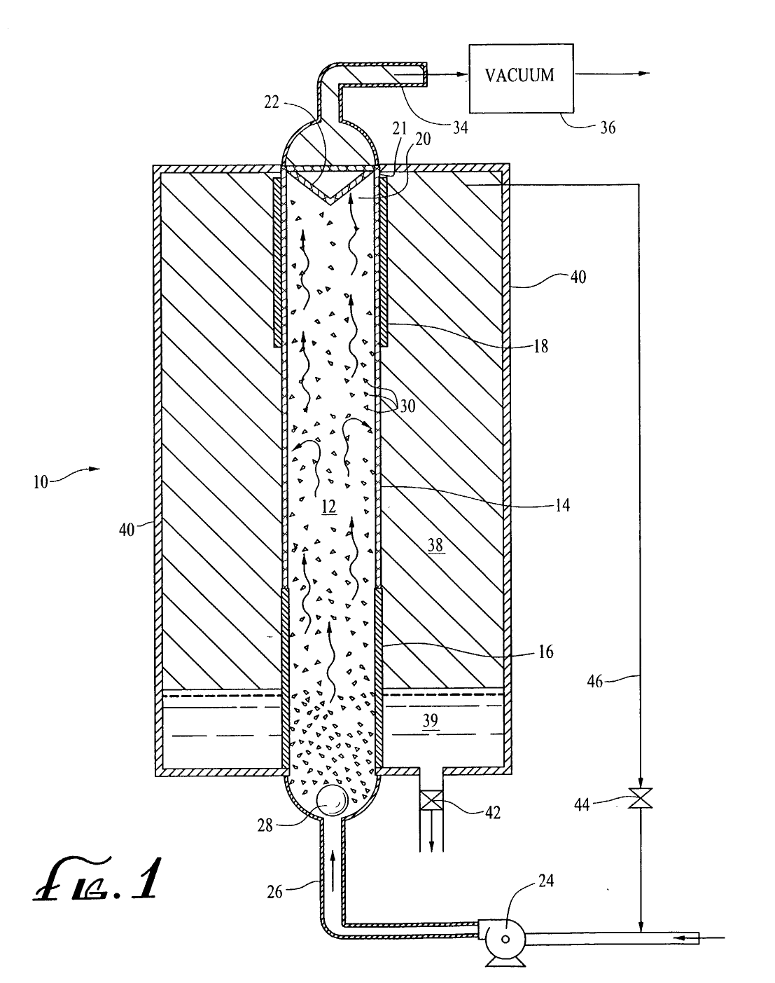

### DESCRIPTION OF THE PREFERRED EMBODIMENT

Referring to the drawing, a preferred embodiment of the invention comprises a separation apparatus 10 comprising an inner tube or chamber 12 defined mainly by a generally cylindrical screen housing 14. A solid cylindrical housing portion 16 is disposed about a lower portion, and a solid cylindrical wall member 18 disposed about the upper portion of the chamber 12 and is spaced from the upper wall of chamber 12, as shown at 21, for a purpose hereinafter described. A conical filtering screen 22 is disposed atop chamber 12.

A pump 24 supplies immiscible liquid-oil mixture via a conduit 26 and a ball check valve 28 which admits and retains the liquid. A large plurality of particles 30 is disposed in chamber 12, which particles in the present invention are formed of polyethylene plastic. The polyethylene particles are wettable by oil, but not by water. The embodiment herein described is utilized in the separation of oil, as a first liquid, from water, a second liquid. The particles may also be formed of polystyrene, polypropylene, or polyamide.

The solid particles preferably have a density between the densities of the oil and water, and the particle density is close to that of the liquid mixture. The solid particles fluidize because of the density between those of oil and water.

The polyethylene particles are thus wetted by the oil and the water is repulsed. The particles are thus suspended and fluidized by upward flow of the liquid mixture and the particles are suspended by the upper flow of the liquid in the inner chamber.

The oil, because of the lighter phase of lower specific gravity of the mixture, is continuously collected at the top of the chamber, and flows outwardly via the filter 22, which filter retains the particles in the inner chamber 12 and passes the separated oil, or first liquid, outwardly through an outlet to 34, formed of polyethylene material wettable only by oil. Upward flow of the oil is aided by operation of a vacuum pump 36, which provides a relatively low partial vacuum.

The solid wall portion 16 extends about the lower portion of the inner chamber 12 and prevents oil and water mixture and particles from passing outwardly into the lower portion of outer chamber 38.

The water or second liquid, separated from the oil or first liquid, passes outwardly via fine mesh screen wall 14 which retains the particles in the inner chamber and into an outer chamber 38 which is defined between the screen 14 and walls 16, 18 into outer chamber 38 which is defined by solid walls of outer housing 40.

The oil, or first and lighter phase, is continuously collected at the top of the chamber and passes outwardly from the separator via outlet 34, and water continuously exits the inner chamber via the screen wall 14 of the inner chamber.

The lower solid wall portion of the inner chamber prevents water in the lower portion of the outer chamber 38 from mixing incoming immiscible liquid mixture in lower portion of the inner chamber.

A drain valve 42 is provided at the bottom portion of the housing 40 to drain the separated water in the outer chamber 38.

The separator and system are adapted for continuous operation by disposing of the separated second liquid or water via the valve 42 or other appropriate means, and the separated oil or first liquid flows continuously outwardly from the outlet tube 34. A control valve 44 in a line 46 extending between the upper interior of the outer chamber 38, and an input pump 24 in line 26, provide for re-entry of any immiscible liquid in the upper portion of the outer chamber into the input of immiscible fluid via line 26, if needed.

It will be understood that various changes and modifications may be made from the preferred embodiments discussed above without departing from the scope of the present invention, which is established by the following claims and equivalents thereof.

The inventor claims:

1. A liquid mixture separator comprising:
a first chamber for containing a mixture of a first liquid and a second liquid,
a second chamber adjacent to said first chamber and in liquid communication therewith via a screen wall between the first and second chambers,
means to introduce said mixture into the first chamber,
a substantial plurality of particles in said first chamber and in contact with said mixture, said particles comprising a material which attracts said first liquid and does not attract said second liquid, whereby said first liquid is separated from the second liquid and congregates on the plurality of said particles,
said particles being retained in the first chamber by said screen wall, and separated second liquid passing from the first chamber into the second chamber via the screen wall,
outlet means at an upper portion of the first chamber for outward flow of said first liquid from the separator, and
means for draining separated second liquid from the second chamber.

2. A separator according to claim 1, wherein said inlet means for the liquid mixture comprises a one-way valve to admit the liquid mixture to a lower portion of the first chamber.

3. A separator according to claim 1, wherein said mixture comprises an oil-water mixture, said first liquid is oil and said second liquid is water.

4. A separator according to claim 1, wherein said particles are formed of one of (1) polystyrene, (2) polyethylene, (3) polypropylene, (4) polyamide.

5. A separator according to claim 1, wherein said second liquid is water and said first liquid is one of (1) kerosene, (2) gasoline, (3) mineral oil, (4) vegetable oil, (5) petroleum oil.

6. A separator according to claim 1, wherein said particles are formed of material having a wettability angle which is less than 90°.

7. A separator according to claim 1, wherein said first and second chambers are generally concentric and said second chamber is disposed radially outwardly of the first chamber.

8. A separator according to claim 1, wherein said screen wall retains said particles in the first chamber and passes separated second liquid from the first chamber into the second chamber.

9. A separator according to claim 1, and further comprising an outlet from an upper portion of the first chamber for a separated first liquid.

10. A separator according to claim 1, and further including a screen at an upper portion of a first chamber to retain said particles and pass separated first liquid from the separator.

11. A separator according to claim 1, wherein said plurality of particles comprises a vast number of particles.

12. A separator according to claim 9, and further comprising means to apply a partial vacuum at said outlet to improve outflow of separated liquid from the first chamber.

13. A separator according to claim 1, and further comprising a wall disposed about a lower portion of the first chamber to separate said liquid mixture in the first chamber from second liquid in a lower portion of the second chamber.

14. A separator according to claim 9, and further comprising a wall extending about an upper portion of the first chamber to retain separated first liquid for passage through said outlet.

15. A separator according to claim 14, wherein said wall has an upper edge portion spaced a short distance from an upper wall of the separator for outward flow of any separated first liquid adjacent to upper wall of the separator.

16. A liquid mixture separator comprising:
a first chamber for containing a mixture of an oil and water,
a second chamber generally concentric with and disposed radially outwardly of said first chamber and in liquid communication therewith via a screen wall between the first and second chambers,
means to introduce said mixture into the first chamber,
a substantial plurality of particles in said first chamber and in contact with said mixture, said particles comprising a material which attracts said oil and does not attract said water,
said particles comprising at least one of (1) polystyrene, (2) polyethylene, (3) polypropylene, (4) polyamide,
said particles being retained in the first chamber by said polyamide screen wall, and separated water passing from the first chamber into the second chamber via the screen wall,
outlet means at an upper portion of the first chamber for outward flow of said oil from the separator, and
means for draining separated water from the second chamber.

17. A separator according to claim 16, wherein said screen wall retains said particles in the first chamber and passes separated water from the first chamber into the second chamber.

18. A separator according to claim 16, and further comprising an outlet from an upper portion of the first chamber for a separated oil.

19. A separator according to claim 16, and further including a screen at an upper portion of a first chamber to retain said particles and pass separated oil from the separator.

20. a separator according to claim 18, and further comprising means to apply a partial vacuum at said outlet to improve outflow of separated oil from the first chamber.

21. A separator according to claim 16, and further comprising a wall disposed about a lower portion of the first chamber to separate said oil in the first chamber from water in a lower portion of the second chamber.

22. A separator according to claim 18, and further comprising a wall extending about an upper portion of the first chamber to retain separated oil for passage through said outlet.

23. A continuous liquid mixture separator comprising:
a first chamber for containing a mixture of a petroleum oil and water,
a second chamber generally concentric with and disposed radially outwardly of said first chamber and in liquid communication therewith via a screen wall between the first and second chambers,
means to introduce said mixture into the first chamber,
a substantial plurality of particles in said first chamber and in contact with said mixture, said particles comprising a material which attracts said petroleum oil and does not attract said water,
said particles comprising at least one of (1) polystyrene, (2) polyethylene,
whereby said petroleum oil is separated from the water and congregates on said plurality of particles,
said particles being retained in the first chamber by said screen wall, and separated water passing from the first chamber into the second chamber via the screen wall,
outlet means at an upper portion of the first chamber for outward flow of said petroleum oil from the separator, and
means for draining separated water from the second chamber.

24. A separator according to claim 23, wherein said particles are formed of one of (1) polypropylene, (2) polyamide.

25. A separator according to claim 23, wherein said screen wall retains said particles in the first chamber and passes separated water from the first chamber into the second chamber.

26. A separator according to claim 23, and further comprising an outlet from an upper portion of the first chamber for a separated petroleum oil.

27. A separator according to claim 23, and further including a screen at an upper portion of a first chamber to retain said particles and pass separated petroleum oil from the separator.

28. A separator according to claim 26, and further comprising means to apply a partial vacuum at said outlet to improve outflow of separated petroleum oil from the first chamber.

29. A separator according to claim 23, and further comprising a wall disposed about a lower portion of the first chamber to separate said petroleum oil in the first chamber from water in a lower portion of the second chamber.

30. A separator according to claim 26, and further comprising a wall extending about an upper portion of the first chamber to retain separated petroleum oil for passage through said outlet.
